(19) United States
(12) Patent Application Publication
(10) Pub. No.: US 2016/0266929 A1
(43) Pub. Date: Sep. 15, 2016

(54) CPU SCHEDULING METHOD, TERMINAL DEVICE AND PROCESSING DEVICE

(71) Applicant: HUAWEI TECHNOLOGIES CO., LTD., Shenzhen (CN)

(72) Inventor: Chenggang LU, Beijing (CN)

(73) Assignee: HUAWEI TECHNOLOGIES CO., LTD., Shenzhen (CN)

(21) Appl. No.: 15/160,324

(22) Filed: May 20, 2016

Related U.S. Application Data
(63) Continuation of application No. PCT/CN2014/078098, filed on May 22, 2014.

(30) Foreign Application Priority Data
Nov. 21, 2013 (CN) 201310594340.7

(51) Int. Cl. G06F 9/48

(52) U.S. Cl. CPC G06F 9/4881

(57) ABSTRACT

The present invention discloses a CPU scheduling method, apparatus, and system based on a heterogeneous multi-core system, relates to the technical field of CPU scheduling of a computer system, and is used for implementing CPU scheduling for the heterogeneous multi-core system, properly using resources, improving system performance, and giving full play to advantages of the heterogeneous multi-core system. The CPU scheduling method based on a heterogeneous multi-core system includes: receiving performance type information that is of an application program and sent by a processing device; and scheduling a CPU for the application program according to the performance type information of the application program.

### CROSS-REFERENCE

This application is a continuation of International Application No. PCT/CN2014/078098, filed on May 22, 2014, which claims priority to Chinese Patent Application No.201310594340.7, filed on Nov. 21, 2013, both of which are hereby incorporated by reference in their entireties.

### TECHNICAL FIELD

The present invention relates to the technical field of CPU scheduling of a computer system, and in particular, to a CPU scheduling method, apparatus, and system based on a heterogeneous multi-core system.

### BACKGROUND

Currently, a mainstream operating system scheduler supports a homogeneous multi-core system, for example, a symmetrical multi-processing (SMP) system. However, a heterogeneous multi-core system refers to an architecture in which not all cores in a processor are the same, for example, an asymmetrical multi-processing system such as a big.LITTLE architecture. An operating system based on the heterogeneous multi-core system mainly uses the following two manners to schedule a central processing unit (CPU).

One manner is: separately using a CPU core with high performance and a CPU core with low power consumption as a processor cluster in a hardware architecture. The operating system performs switching between processor clusters according to system performance and power consumption requirements by using a frequency regulation module provided by the operating system. Processor cluster switching is performed according to the performance and power consumption requirements, and only one processor cluster runs at the same time, which cannot give full play to advantages of a heterogeneous multi-core CPU architecture. In a running process, when a system is at a performance switch point, frequent switching between two processor clusters may occur, which causes a performance loss.

The other manner is: dividing CPUs into different scheduling domains by using a CPU scheduling technology of an existing operating system (CPUs in a same scheduling domain are homogeneous CPUs), and placing, according to priorities of tasks and historical load information of the tasks, the tasks into the different scheduling domains for scheduling. In this CPU scheduling technology, a decision for grouping the tasks is inaccurate, and the tasks cannot be accurately allocated to corresponding scheduling domains

### SUMMARY

Embodiments of the present invention provide a CPU scheduling method, apparatus, and system based on a heterogeneous multi-core system, so as to implement CPU scheduling for the heterogeneous multi-core system.

To achieve the foregoing objective, the following technical solutions are adopted in the embodiments of the present invention:

According to a first aspect, an embodiment of the present invention provides a CPU scheduling method based on a heterogeneous multi-core system, including:

receiving performance type information that is of an application program and sent by a processing device; and scheduling a CPU for the application program according to the performance type information of the application program.

In a first possible implementation manner of the first aspect, before the receiving performance type information that is of an application program and sent by a processing device, the method further includes:

collecting running information of the application program; and

sending the running information of the application program to the processing device, so that the processing device determines the performance type information of the application program according to the running information of the application program.

In the first possible implementation manner of the first aspect, a second possible implementation manner of the first aspect is further provided, where the collecting running information of the application program includes:

collecting the running information of the application program according to a preset time interval by using a preset collector.

In either of the foregoing two possible implementation manners of the first aspect, a third possible implementation manner of the first aspect is further provided, where the sending the running information of the application program to the processing device, so that the processing device determines the performance type information of the application program according to the running information of the application program includes:

sending the running information of the application program to the processing device, so that the processing device performs a statistical analysis on the running information of the application program, so as to obtain the performance type information of the application program.

According to a second aspect, an embodiment of the present invention provides a CPU scheduling method based on a heterogeneous multi-core system, including:

receiving running information that is of an application program and sent by a terminal device, where the running information of the application program is obtained by the terminal device by means of collection;

determining performance type information of the application program according to the running information of the application program; and

sending the performance type information of the application program to the terminal device, so that the terminal device schedules a CPU for the application program according to the performance type information of the application program.

In a first possible implementation manner of the second aspect, that the running information of the application program is obtained by the terminal device by means of collection includes:

the running information of the application program is obtained by the terminal device by means of collection according to a preset time interval by using a preset collector.

In the second aspect or the first possible implementation manner of the second aspect, a second possible implementation manner of the second aspect is further provided, where the determining performance type information of the application program according to the running information of the application program includes:

performing a statistical analysis on the running information of the application program, so as to determine the performance type information of the application program.

According to a third aspect, an embodiment of the present invention provides a terminal device, including:

a receiving module, configured to receive performance type information that is of an application program and sent by a processing device; and

a scheduling module, configured to schedule a CPU for the application program according to the performance type information that is of the application program and obtained by the receiving module.

In a first possible implementation manner of the third aspect, before the receiving module receives the performance type information that is of the application program and sent by the processing device, the terminal device further includes:

a collecting module, configured to collect running information of the application program; and a sending module, configured to send the running information that is of the application program and obtained by the collecting module to the processing device, so that the processing device determines the performance type information of the application program according to the running information of the application program.

In the first possible implementation manner of the third aspect, a second possible implementation manner of the third aspect is further provided, where the collecting module is specifically configured to collect the running information of the application program according to a preset time interval by using a preset collector.

In either of the foregoing two possible implementation manners of the third aspect, a third possible implementation manner of the third aspect is further provided, where the sending module is specifically configured to send the running information of the application program to the processing device, so that the processing device performs a statistical analysis on the running information of the application program, so as to obtain the performance type information of the application program.

According to a fourth aspect, an embodiment of the present invention provides a processing device, including:

a receiving module, configured to receive running information that is of an application program and sent by a terminal device, where the running information of the application program is obtained by the terminal device by means of collection;

a determining module, configured to determine performance type information of the application program according to the running information that is of the application program and received by the receiving module; and

a sending module, configured to send the performance type information that is of the application program and obtained by the determining module to the terminal device, so that the terminal device schedules a CPU for the application program according to the performance type information of the application program.

In a first possible implementation manner of the fourth aspect, the determining module is specifically configured to perform a statistical analysis on the running information of the application program, so as to determine the performance type information of the application program.

According to a fifth aspect, an embodiment of the present invention provides a CPU scheduling system based on a heterogeneous multi-core system, including the terminal device according to the third aspect or any possible implementation manner of the third aspect, and the processing device according to the fourth aspect or any possible implementation manner of the fourth aspect.

The embodiments of the present invention provide the CPU scheduling method, apparatus, and system based on a heterogeneous multi-core system, where running information of an application program is collected, and the running information of the application program is sent to a processing device; the processing device determines performance type information of the application program according to the running information of the application program, and sends the performance type information of the application program to a terminal device; the terminal device schedules a CPU for the application program according to the performance type information of the application program, that is, the terminal device acquires the performance type information of the application program by means of interaction between the terminal device and the processing device, and implements CPU scheduling for the heterogeneous multi-core system according to the performance type information of the application program, so as to properly use resources, improve system performance, and give full play to advantages of the heterogeneous multi-core system.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and persons of ordinary skill in the art may still derive other drawings from these accompanying drawings without creative efforts.

FIG. 1 is a schematic diagram of a CPU scheduling method based on a heterogeneous multi-core system according to an embodiment of the present invention;

FIG. 2 is a schematic diagram of another CPU scheduling method based on a heterogeneous multi-core system according to an embodiment of the present invention;

FIG. 3 is a schematic diagram of another CPU scheduling method based on a heterogeneous multi-core system according to an embodiment of the present invention;

FIG. 4 is a schematic flowchart of a CPU scheduling method based on a heterogeneous multi-core system according to an embodiment of the present invention;

FIG. 5 is a schematic flowchart of a CPU scheduling method based on a heterogeneous multi-core system according to Embodiment 1 of the present invention;

FIG. 6 is a schematic flowchart of a CPU scheduling method based on a heterogeneous multi-core system according to Embodiment 2 of the present invention;

FIG. 7 is a schematic structural diagram of a terminal device according to an embodiment of the present invention;

FIG. 8 is a schematic structural diagram of another terminal device according to an embodiment of the present invention;

FIG. 9 is a schematic structural diagram of a processing device according to an embodiment of the present invention;

FIG. 10 is a schematic structural diagram of an entity of a terminal device according to an embodiment of the present invention; and

FIG. 11 is a schematic structural diagram of an entity of a processing device according to an embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are merely some but not all of the embodiments of the present invention. All other embodiments obtained by persons of ordinary skill in the art based on the embodiments of the present invention without creative efforts shall fall within the protection scope of the present invention.

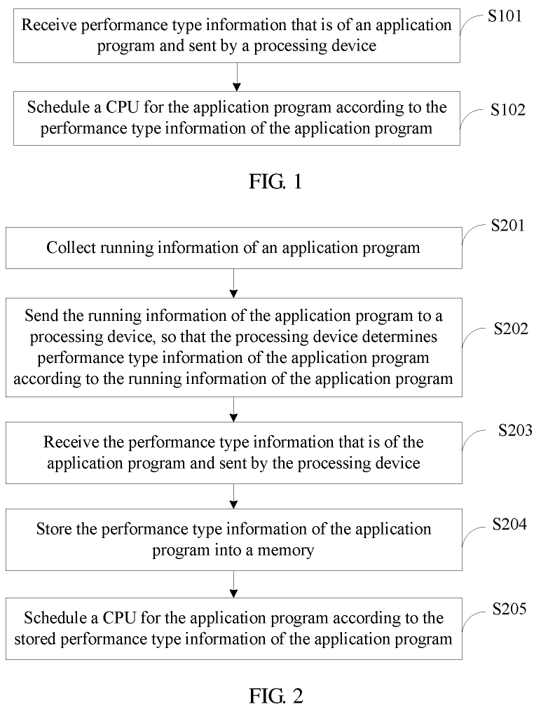

The present invention provides a CPU scheduling method based on a heterogeneous multi-core system. As shown in FIG. 1, the method includes:

S101. Receive performance type information that is of an application program and sent by a processing device.

S102. Schedule a CPU for the application program according to the performance type information of the application program.

Optionally, before step S101, the CPU scheduling method further includes:

collecting running information of the application program; and

sending the running information of the application program to the processing device, so that the processing device determines the performance type information of the application program according to the running information of the application program.

Optionally, after step S101 and before step S102, the method further includes:

storing the performance type information of the application program into a memory.

Further, a terminal device schedules the CPU for the application program according to the stored performance type information of the application program.

For the foregoing CPU scheduling method based on a heterogeneous multi-core system, an embodiment of the present invention provides a specific CPU scheduling method based on a heterogeneous multi-core system. As shown in FIG. 2, the method includes:

S201. Collect running information of an application program.

The collecting running information of an application program may include: collecting the running information of the application program according to a preset time interval by using a preset collector.

The running information of the application program may be CPU consumption information and IO consumption information that are of the application program, or may be power consumption information of the application program, but certainly is not limited thereto.

The preset time interval may be program code that is written in a background service program and that has a timer function, and the time interval may be properly set according to different terminal devices, and may be two seconds or five seconds, but certainly is not limited thereto.

The preset collector may be an existing collector in an operating system, for example, a tool such as top, sar, or iostat that is provided by a Linux kernel in the Linux operating system, or may be a new user-designed collector, but certainly is not limited thereto.

S202. Send the running information of the application program to a processing device, so that the processing device determines performance type information of the application program according to the running information of the application program.

That the processing device determines performance type information of the application program according to the running information of the application program includes: the processing device performs a statistical analysis on the running information of the application program, so as to obtain the performance type information of the application program.

The statistical analysis may be: the application program runs in different scenarios, and the processing device uses a statistical algorithm to process and analyze running information in the different scenarios, so as to obtain the performance type information of the application program.

The performance type information that is of the application program and determined by the processing device may be an analysis result obtained by analyzing the CPU consumption information and the IO consumption information that are of the application program, where the analysis result may indicate whether the application program is a CPU-intensive application or an IO-intensive application, or both a CPU-intensive application and an IO-intensive application. If the application program is a CPU-intensive application, it indicates that performance of the application program is relatively high. If the application program is an IO-intensive application, it indicates that the performance of the application program is relatively low. If the application program is both a CPU-intensive application and an IO-intensive application, a performance level of the application program is determined according to an actual situation.

The processing device may also be referred to as a third party system, and the processing device may be a local service process, or may be a remote server or cloud, but certainly is not limited thereto.

S203. Receive the performance type information that is of the application program and sent by the processing device.

S204. Store the performance type information of the application program into a memory.

S205. Schedule a CPU for the application program according to the stored performance type information of the application program.

CPUs may be divided according to different allocation mechanisms, so as to obtain different CPU scheduling domains. A terminal device allocates the application program to a proper CPU scheduling domain according to the stored performance type information of the application program, so that a CPU in the CPU scheduling domain to which the application program is allocated runs the application program.

Optionally, the CPUs may be divided into to a processor cluster with high power consumption and a processor cluster with low power consumption according to power consumption performance of the CPUs; then, the CPU scheduling domains are the processor cluster with high power consumption and the processor cluster with low power consumption. In the Linux operating system, a CPU scheduling domain is referred to as a cpuset, where the cpuset is in one-to-one correspondence with a system resource control group (cgroup). Therefore, a cgroup may be allocated to the application program according to the performance type information of the application program.

The cgroup is a mechanism that is in Linux and that controls, by using a management mode of a tree structure, one or more processes to use system physical resources, and the cgroup mainly includes a method for allocating resources such as a CPU, a memory, a disk input/output (disk I/O), and a network class to processes in the system. The cpuset is a processor cluster that includes at least one CPU.

For example, it is assumed that the Linux system includes four CPUs, where two CPUs whose serial numbers are 0 and 1 are CPUs with high performance, and two CPUs whose serial numbers are 2 and 3 are CPUs with low power consumption. When the operating system is started, the cpuset may be used to allocate the two CPUs whose serial numbers are 0 and 1 to a cgroupA, and allocate the two CPUs whose serial numbers are 2 and 3 to a cgroupB. Then, a process in the cgroupA can only run on the two CPUs whose serial numbers are 0 and 1, and a process in the cgroupB can only run on the two CPUs whose serial numbers are 2 and 3. In this case, cgroup and cpuset technologies may be used to allocate the application program to different cgroups according to whether the application program is CPU-intensive or IO-intensive.

Alternatively, the terminal device sets, for the application program according to the performance type information of the application program, a processor cluster that needs to be scheduled. Specifically, a correspondence between the performance type information of the application program and the processor cluster may be pre-stored in the operating system; in this step, by querying the correspondence according to the obtained performance type information of the application program, the terminal device can obtain the processor cluster allocated to the application program.

For example, it is assumed that multiple CPUs in a computer system are divided into two processor clusters, where one of the two processor clusters is with high performance, and the other one is with low performance In this case, when an application program is a CPU-intensive application, an operating system allocates, according to a correspondence, the application program to the processor cluster with high performance for CPU scheduling; when the application program is an IO-intensive application, the operating system allocates, according to the correspondence, the application program to the processor cluster with low performance for CPU scheduling. For an application program that is both CPU-intensive and IO-intensive, to achieve optimal user experience, a processing device may determine, according to data about power consumption per hour of the application program during running and impact of running of the application program on the user experience, to place the application program into a proper CPU scheduling domain for scheduling and execution.

This embodiment of the present invention provides the CPU scheduling method based on a heterogeneous multi-core system, where running information of an application program is collected, and the running information of the application program is sent to a processing device, so that the processing device determines performance type information of the application program according to the running information of the application program; the performance type information that is of the application program and sent by the processing device is received, and a CPU is scheduled for the application program according to the performance type information of the application program, so as to implement CPU scheduling for the heterogeneous multi-core system, properly use resources, improve system performance, and give full play to advantages of the heterogeneous multi-core system.

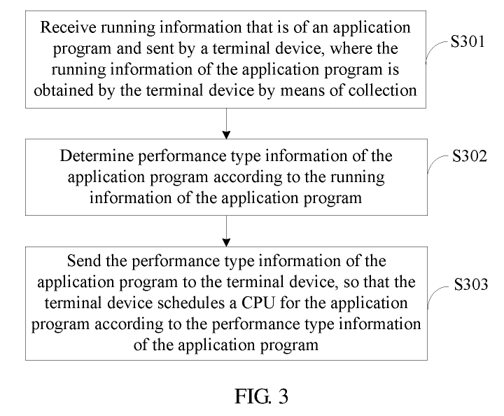

An embodiment of the present invention provides a CPU scheduling method based on a heterogeneous multi-core system. As shown in FIG. 3, the method includes:

S301. Receive running information that is of an application program and sent by a terminal device, where the running information of the application program is obtained by the terminal device by means of collection.

That the running information of the application program is obtained by the terminal device by means of collection includes: the running information of the application program is obtained by the terminal device by means of collection according to a preset time interval by using a preset collector.

The running information of the application program may be CPU consumption information and IO consumption information that are of the application program, or may be power consumption information of the application program, but certainly is not limited thereto.

The preset time interval may be program code that is written in a background service program and that has a timer function, and the time interval may be properly set according to different terminal devices, and may be two seconds or five seconds, but certainly is not limited thereto.

The preset collector may be an existing collector in an operating system, for example, a tool such as top, sar, or iostat that is provided by a Linux kernel in the Linux operating system, or may be a new user-designed collector, but certainly is not limited thereto.

S302. Determine performance type information of the application program according to the running information of the application program.

The determining performance type information of the application program according to the running information of the application program includes: performing a statistical analysis on the running information of the application program, so as to obtain the performance type information of the application program.

The statistical analysis may be: the application program runs in different scenarios, and the processing device uses a statistical algorithm to process and analyze running information in the different scenarios, so as to obtain the performance type information of the application program.

The performance type information that is of the application program and determined by the processing device may be an analysis result obtained by analyzing the CPU consumption information and the IO consumption information that are of the application program, where the analysis result may indicate whether the application program is a CPU-intensive application or an IO-intensive application, or both a CPU-intensive application and an IO-intensive application. If the application program is a CPU-intensive application, it indicates that performance of the application program is relatively high. If the application program is an IO-intensive application, it indicates that the performance of the application program is relatively low. If the application program is both a CPU-intensive application and an IO-intensive application, a performance level of the application program is determined according to an actual situation.

The processing device may also be referred to as a third party system, and the processing device may be a local service process, or may be a remote server or cloud, but certainly is not limited thereto.

S303. Send the performance type information of the application program to the terminal device, so that the terminal device schedules a CPU for the application program according to the performance type information of the application program.

Optionally, in step S303, the performance type information of the application program is sent to the terminal device, so that the terminal device receives the performance type information of the application program, stores the performance type information of the application program into a memory, and schedules a CPU for the application program according to the stored performance type information of the application program.

This embodiment of the present invention provides the CPU scheduling method based on a heterogeneous multi-core system, where running information that is of an application program and sent by a terminal device is received, performance type information of the application program is determined according to the running information of the application program, and the performance type information of the application program is sent to the terminal device, so that the terminal device schedules a CPU for the application program according to the performance type information of the application program, so as to implement CPU scheduling for the heterogeneous multi-core system, properly use resources, improve system performance, and give full play to advantages of the heterogeneous multi-core system.

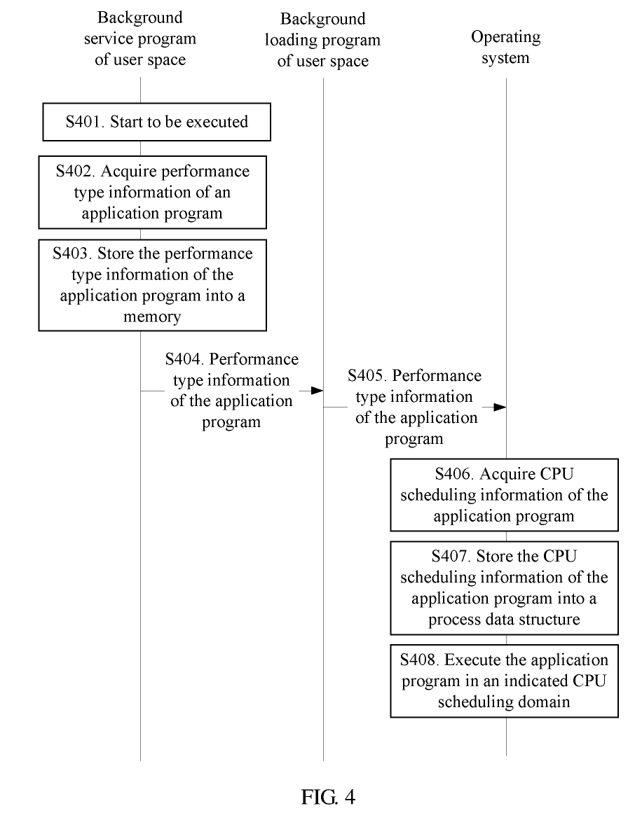

For the foregoing CPU scheduling method based on a heterogeneous multi-core system, an embodiment of the present invention provides a specific CPU scheduling method based on a heterogeneous multi-core system. As shown in FIG. 4, the method includes:

S401. Start a terminal device system, and start a background service program of user space.

The background service program of the user space may be a background service program that has been embedded in the user space in the heterogeneous multi-core system, and the background program is a program that a user cannot directly contact, and is different from an application program.

Generally, an operating system is divided into two parts, where one part is core software and is also referred to as kernel space, and the other part is a common application program and may also be referred to as user space. Code of the common application program in the user space runs at a lower privilege level. The common application program is allowed to use only a part of system resources, cannot use some specific system functions, and cannot directly access the kernel space and a hardware device, and there are some other specific usage limitations.

S402. The background service program of the user space acquires performance type information of an application program.

The application program refers to a computer program developed and run on the operating system for the purpose of completing one or more specific tasks; the application program runs in the user space, and can interact with the user, and generally has a visible user interface.

The performance type information of the application program refers to a type to which the application program belongs according to a performance level.

This step S402 may specifically include:

(1) The background service program of the user space collects running information of the application program.

For example, the running information of the application program may be CPU consumption information and IO consumption information that are of the application program, or may be power consumption information of the application program, but certainly is not limited thereto.

Specifically, that the background service program of the user space collects running information of the application program includes: the background service program of the user space collects the running information of the application program according to a preset time interval by using a preset collector.

The preset time interval may be program code that is written in the background service program and that has a timer function, and the time interval may be properly set according to different terminal devices, and may be two seconds or five seconds, but certainly is not limited thereto.

The preset collector may be an existing collector in the operating system, for example, a tool such as top, sar, or iostat that is provided by a Linux kernel in the Linux operating system, or may be a new user-designed collector.

For example, it is assumed that the Linux operating system is used, when the background service program is running, a top collector provided by the Linux kernel may be used to collect, once per two seconds, CPU consumption information and IO consumption information that are of a current application program.

(2) The background service program of the user space acquires the performance type information that is of the application program and determined by using the running information of the application program.

The performance type information that is of the application program and determined by using the running information of the application program may be an analysis result obtained by analyzing the CPU consumption information and the IO consumption information that are of the application program, where the analysis result may indicate whether the application program is a CPU-intensive application or an IO-intensive application, or both a CPU-intensive application and an IO-intensive application. If the application program is a CPU-intensive application, it indicates that performance of the application program is relatively high. If the application program is an IO-intensive application, it indicates that the performance of the application program is relatively low. If the application program is both a CPU-intensive application and an IO-intensive application, a performance level of the application program is determined according to an actual situation.

Optionally, this step (2) may be that the background service program obtains the performance type information of the application program according to the running information of the application program by means of analysis.

Alternatively, this step (2) includes: the background service program of the user space sends the running information of the application program to a processing device; the processing device determines the performance type information of the application program according to the running information of the application program; and the background service program of the user space receives the performance type information that is of the application program and sent by the processing device.

The processing device may also be referred to as a third party system, and the processing device may be a local service process, or may be a remote server or cloud, but certainly is not limited thereto.

That the processing device determines the performance type information of the application program according to the running information of the application program includes: the processing device performs a statistical analysis on the running information of the application program, so as to obtain the performance type information of the application program.

The statistical analysis may be: the application program runs in different scenarios, and the processing device uses a statistical algorithm to process and analyze running information in the different scenarios, so as to obtain the performance type information of the application program. For example, for CPU consumption information of an application program, CPU idle rates of the application program in different scenarios may be obtained on a server of the processing device. From a large amount of data statistics, if an average of the CPU idle rates of the application program is extremely large, the application program is an IO-intensive application, and it indicates that the application program should be placed into a CPU scheduling domain with low performance for scheduling and execution. If the average of the CPU idle rates of the application program is extremely small, the application program is a CPU-intensive application, and it indicates that the application program should be placed into a CPU scheduling domain with high performance for scheduling and execution.

For example, in the Linux operating system, the background service program embedded in the user space transmits CPU consumption information and 10 consumption information that are of a current running application program to a cloud, and the cloud performs a statistical analysis on the received CPU consumption information and 10 consumption information that are of the application program, so as to determine whether the application program is a CPU-intensive application or an IO-intensive application, or both a CPU-intensive application and an IO-intensive application. After obtaining performance type information of the current running application program, the cloud transmits the performance type information of the application program to the background service program, and the background service program receives the latest performance type information that is of the application program and transmitted by the cloud.

S403. The background service program of the user space stores the performance type information of the application program into a memory.

For example, in the Linux operating system, the background service program embedded in the user space stores, in the memory, the performance type information sent by the cloud that the application program belongs to a CPU-intensive application or an IO-intensive application, or both a CPU-intensive application and an IO-intensive application, so that when loading the application program, the operating system may acquire the performance type information of the application program; therefore, the operating system places a process of the application program into different scheduling domains for execution.

S404. When the application program starts to be executed, a background loading program of the user space acquires the performance type information of the application program by using the background service program of the user space.

For example, when an application program starts to be executed, the background loading program of the user space acquires performance type information of the application program by using the background service program of the user space, that is, whether the application program is a CPU-intensive program or an IO-intensive program is acquired.

S405. When an operating system loads the application program, the background loading program of the user space invokes an interface of the operating system to send the performance type information of the application program to the operating system; correspondingly, the operating system receives the performance type information of the application program.

For the interface of the operating system, an existing interface of the operating system may be used. For example, the interface of the operating system may be a system resource control group (cgroup) configuration interface provided by the Linux system for the user space, or may be a self-implemented interface.

S406. Acquire CPU scheduling information of the application program according to the performance type information of the application program.

CPU scheduling domains are different area sets obtained by dividing CPUs according to different allocation mechanisms. For example, during establishing of a hardware architecture, the CPUs may be divided into a processor cluster with high power consumption and a processor cluster with low power consumption according to power consumption performance of the CPUs; then, the CPU scheduling domains are the processor cluster with high power consumption and the processor cluster with low power consumption. In the Linux operating system, a CPU scheduling domain is referred to as a cpuset, where the cpuset is in one-to-one correspondence with a cgroup.

Optionally, the operating system may allocate a cgroup to the application program according to the performance type information of the application program.

For example, in the Linux operating system, cgroup and cpu set (cpuset) technologies are used, where the cgroup is a mechanism that is in Linux and that controls, by using a management mode of a tree structure, one or more processes to use system physical resources, and the cgroup mainly includes a method for allocating resources such as a CPU, a memory, a disk I/O, and a network class to processes in the system. The cpuset is a processor cluster that includes at least one CPU.

It is assumed that the Linux operating system includes four CPUs, where two CPUs whose serial numbers are 0 and 1 are CPUs with high performance, and two CPUs whose serial numbers are 2 and 3 are CPUs with low power consumption. When the operating system is started, the cpuset may be used to allocate the two CPUs whose serial numbers are 0 and 1 to a cgroupA, and allocate the two CPUs whose serial numbers are 2 and 3 to a cgroupB. A process in the cgroupA can only run on the two CPUs whose serial numbers are 0 and 1, and a process in the cgroupB can only run on the two CPUs whose serial numbers are 2 and 3.

In this case, by using the cgroup and cpuset technologies, the operating system may allocate the application program to different cgroups according to whether the application program is CPU-intensive or IO-intensive.

Alternatively, the operating system sets, for the application program according to the performance type information of the application program, a processor cluster that needs to be scheduled.

Specifically, a correspondence between the performance type information of the application program and the processor cluster may be pre-stored in the operating system; in this step, by querying the correspondence according to the obtained performance type information of the application program, the operating system can obtain the processor cluster allocated to the application program.

For example, it is assumed that multiple CPUs in a computer system are divided into two processor clusters, where one of the two processor clusters is with high performance, and the other one is with low performance In this case, when an application program is a CPU-intensive application, an operating system allocates, according to a correspondence, the application program to the processor cluster with high performance for CPU scheduling; when the application program is an IO-intensive application, the operating system allocates, according to the correspondence, the application program to the processor cluster with low performance for CPU scheduling. For an application program that is both CPU-intensive and IO-intensive, to achieve optimal user experience, a processing device may determine, according to data about power consumption per hour of the application program during running and impact of running of the application program on the user experience, to place the application program into a proper CPU scheduling domain for scheduling and execution.

S407. Store the CPU scheduling information of the application program into a process data structure.

Optionally, if the operating system can allocate a cgroup to the application program according to the performance type information of the application program, the cgroup allocated to the application program is used as the CPU scheduling information of the application program and written into the process data structure.

Alternatively, if the operating system sets, for the application program according to the performance type information of the application program, a processor cluster that needs to be scheduled, the processor cluster allocated to the application program is used as the CPU scheduling information of the application program and written into the process data structure.

S408. Schedule and execute the application program according to a CPU scheduling domain indicated by the CPU scheduling information that is of the application program and in the process data structure.

Optionally, the operating system schedules and executes the application program in a cpuset corresponding to the cgroup allocated to the application program.

Alternatively, if a first processor cluster is running currently, it is determined, according to the CPU scheduling information of the application program, whether switching to a second processor cluster needs to be performed. If switching is needed, the switching to the second processor cluster is performed. If switching is not needed, the first processor cluster continues to run.

It should be noted that the background service program of the user space, the background loading program of the user space, and the operating system all belong to a terminal device, and are used for interaction between the terminal device and the processing device in an actual process.

This embodiment of the present invention provides the CPU scheduling method based on a heterogeneous multi-core system, where performance type information of an application program is acquired by means of interaction of application program information between a background service program of user space in a terminal device and a cloud in a processing device, and an operating system in the terminal device is enabled to schedule a CPU for the application program according to the performance type information of the application program by using a background loading program of the user space in the terminal device, so as to implement CPU scheduling for the heterogeneous multi-core system, properly use resources, improve system performance, and give full play to advantages of the heterogeneous multi-core system.

The present invention further provides specific instances in the following to schedule a CPU of the foregoing heterogeneous multi-core system. In various specific instances, that a hand-held terminal device uses the Linux operating system is used as an example, and the device includes four CPUs, where CPUs whose serial numbers are 0 and 1 are homogeneous CPUs, and are CPUs with high performance (that is, high power consumption); and CPUs whose serial numbers are 3 and 4 are homogeneous CPUs, and are CPUs with low performance (that is, low power consumption).

### Embodiment 1

For scheduling a CPU based on a heterogeneous multi-core system, the present invention provides a specific implementation solution.

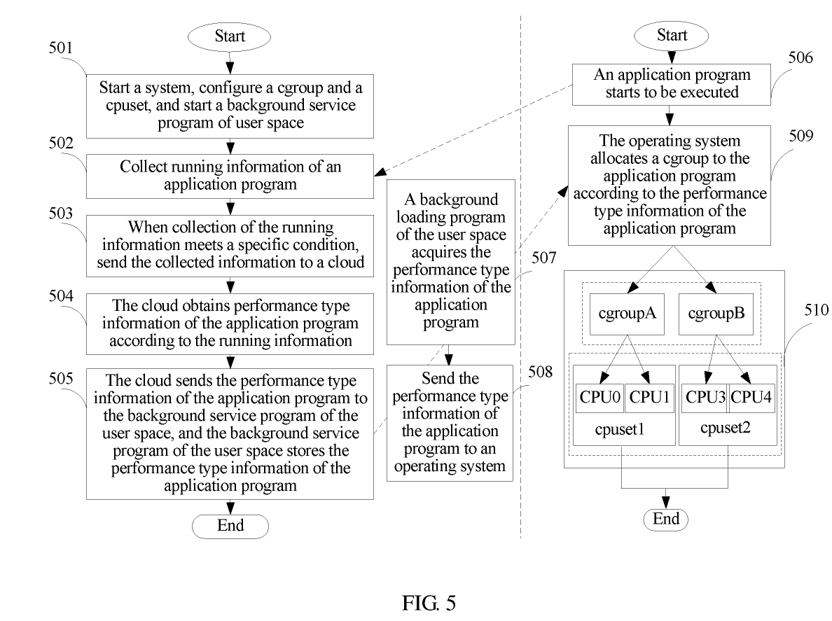

As shown in FIG. 5, a CPU scheduling method based on a heterogeneous multi-core system specifically includes the following steps:

Step 501: Start the Linux operating system, use cgroup and cpuset technologies to configure a CPU, and start a background service program of user space.

The using cgroup and cpuset technologies to configure a CPU includes: using the cpuset technology to perform cpuset division on multiple CPUs according to structures of the CPUs, so as to group CPUs with a same structure into a same cpuset; and establishing cgroups whose quantity is the same as that of divided cpusets, where one cgroup is corresponding to one cpuset, and only a CPU in a corresponding cpuset can be scheduled for a task in a cgroup.

In this specific embodiment, CPUs whose serial numbers are 0 and 1 (a CPU0 and a CPU1 shown in FIG. 5) are grouped as a cpuset1, and CPUs whose serial numbers are 3 and 4 (a CPU2 and a CPU3 shown in FIG. 5) are grouped as a cpuset2. In addition, two cgroups are established, which include a cgroupA and a cgroupB, where the cgroupA is corresponding to the cpuset1, and the cgroupB is corresponding to the cpuset2. As shown in FIG. 5, a task in the cgroupA can only run on a CPU in the cpuset1, and a task in the cgroupB can only run on a CPU in the cpuset2.

Step 502: The background service program of the user space collects CPU consumption information and IO consumption information that are of an application program.

For example, the background service program may collect, once per two seconds by using a collector provided by a kernel, CPU consumption information and IO consumption information that are of a current application program.

Step 503: The background service program sends the collected CPU consumption information and IO consumption information to a cloud when a specific condition is met, and after the sending is completed, historical information in the background service program may be cleared, so as to release a memory resource.

The specific condition may be a capacity threshold, a sending frequency, or the like that is set for the collected information.

Optionally, when the CPU consumption information and the IO consumption information that are collected by the background service program reach the capacity threshold that is set in the background service program, the CPU consumption information and the IO consumption information are sent to the cloud. The capacity threshold that is set in the background service program may be: when the collected CPU consumption information and IO consumption information are 2k, the background service program sends the collected CPU consumption information and the IO consumption information to the cloud, where the capacity threshold may be differently set according to different hand-held terminal devices, but certainly is not limited thereto.

Alternatively, the background service program sends the CPU consumption information and the IO consumption information to the cloud according to the sending frequency that is set in the background service program. For example, CPU consumption information and IO consumption information that are collected per ten seconds are sent to the cloud according to the sending frequency that is set in the background service program, where the sending frequency may be differently set according to different hand-held terminal devices, but certainly is not limited thereto.

Step 504: The cloud receives the CPU consumption information and the IO consumption information that are sent by the background service program, and performs a statistical analysis on the received CPU consumption information and IO consumption information, so as to obtain performance type information of the application program.

Step 505: The cloud sends the performance type information of the application program to the background service program of the user space, and correspondingly, the background service program of the user space stores the performance type information of the application program, and updates the performance type information of the application program into a memory.

Step 506: An application program starts to be executed.

This step may trigger the background service program of the user space to perform steps 502-505, that is, as long as an application program starts to be executed, the background service program of the user space can obtain performance type information of the application program, so that the background service program of the user space stores performance type information of multiple application programs (including a currently-executed application program and an application program executed before).

Step 507: A background loading program of the user space acquires the performance type information of the application program.

Step 508: When the operating system loads the application program, the background loading program of the user space invokes an interface of the operating system to send the performance type information of the application program to the operating system; correspondingly, the operating system receives the performance type information of the application program.

Step 509: The operating system allocates a cgroup to the application program according to the performance type information of the application program.

By using the cgroup and cpuset technologies, the operating system may allocate the application program to different cgroups according to whether the application program is CPU-intensive or IO-intensive.

Specifically, if the application program is a CPU-intensive application, the application program is allocated to the cgroupA. If the application program is an IO-intensive application, the application program is allocated to the cgroupB. If the application program is both a CPU-intensive application and an IO-intensive application, it is determined, according to data about power consumption per hour of the application program during running and impact of running of the application program on user experience, to place the application program into a proper CPU scheduling domain for scheduling and execution.

Step 510: The operating system schedules and executes the application program in a cpuset corresponding to the cgroup allocated to the application program.

Specifically, if the application program is allocated to the cgroupA, because the cgroupA is corresponding to the cpuset1, the CPU0 or the CPU1 is scheduled for the application program, so as to execute the application program. If the application program is allocated to the cgroupB, because the cgroupB is corresponding to the cpuset2, the CPU02 or the CPU3 is scheduled for the application program, so as to execute the application program. If the application program is both a CPU-intensive application and an IO-intensive application, the application program is scheduled and executed in a proper CPU scheduling domain that has been determined

It should be noted that the background service program of the user space, the background loading program of the user space, and the operating system all belong to a terminal device, and are used for interaction between the terminal device and the processing device in an actual process.

This embodiment of the present invention provides the CPU scheduling method based on a heterogeneous multi-core system, where performance type information of an application program is acquired by means of interaction of application program information between a background service program of user space in a terminal device and a cloud in a processing device, and an operating system in the terminal device is enabled to schedule a CPU for the application program according to the performance type information of the application program by using a background loading program of the user space in the terminal device, so as to implement CPU scheduling for the heterogeneous multi-core system, properly use resources, improve system performance, and give full play to advantages of the heterogeneous multi-core system.

### Embodiment 2

For scheduling a CPU based on a heterogeneous multi-core system, the following provides another specific implementation solution according to the foregoing described device.

In this embodiment, a hand-held terminal device with an operating system the same as that in Embodiment 1 is used, that is, the hand-held terminal device uses the Linux operating system. A difference lies in that the operating system in this embodiment schedules, according to information provided by user space, a CPU in a manner of switching a processor cluster. In a hardware architecture of the hand-held terminal device, a CPU with high performance and a CPU with low performance have been divided. That is, CPUs that are with a same structure and whose serial numbers are 0 and 1 are grouped as a processor cluster, where the processor cluster is a processor cluster with high performance; CPUs that are with a same structure and whose serial numbers are 2 and 3 are grouped as a processor cluster, where the processor cluster is a processor cluster with low performance.

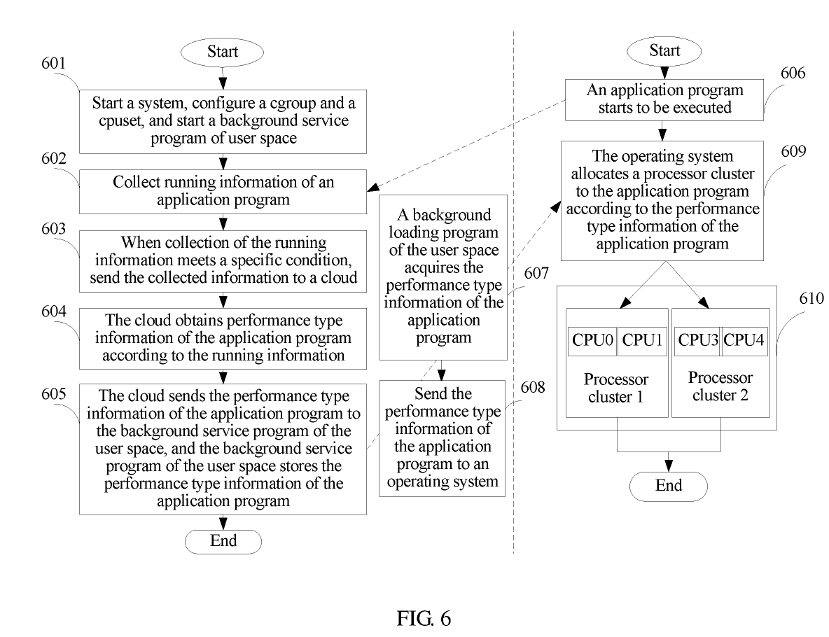

In this embodiment, when an application program starts to be executed, for the first eight steps, that is, steps 601-608 in this embodiment, reference may be made to steps 501-508 in Embodiment 1, and details are not described herein again. A difference lies in that CPUs are divided into two processor clusters. As shown in FIG. 6, after the first eight steps are completed, this embodiment further includes:

Step 609: The operating system allocates a processor cluster to the application program according to the performance type information of the application program.

Specifically, if the application program is a CPU-intensive application, the application program is allocated to the processor cluster with high performance If the application program is an IO-intensive application, the application program is allocated to the processor cluster with low performance. If the application program is both a CPU-intensive application and an IO-intensive application, it is determined, according to data about power consumption per hour of the application program during running and impact of running of the application program on user experience, to place the application program into a proper CPU scheduling domain for scheduling and execution.

Step 610: The operating system performs scheduling and execution in a cpu corresponding to the processor cluster allocated to the application program.

Specifically, when the application program is running, if a first processor cluster is running currently, it is determined, according to the performance type information of the application program, whether switching to a second processor cluster needs to be performed. If switching is needed, an interface provided by operating system kernel space or a new user-designed interface is invoked to perform the switching to the second processor cluster. If switching is not needed, the first processor cluster continues to run.

For example, if the operating system determines, according to the received performance type information of the application program, that the application program is a CPU-intensive application, but the system currently runs on the processor cluster with low performance, switching between processor clusters needs to be performed, that is, switching from the processor cluster with low performance to the processor cluster with high performance needs to be performed for running In this case, at least one of the CPUO and the CPU1 that are in the processor cluster with high performance is scheduled for the application program.

Similarly, if the operating system determines, according to the received performance type information of the application program, that the application program is an IO-intensive application, but the system currently runs on the processor cluster with high performance, switching between processor clusters needs to be performed, that is, switching from the processor cluster with high performance to the processor cluster with low performance needs to be performed for running In this case, at least one of the CPU2 and the CPU3 that are in the processor cluster with low performance is scheduled for the application program.

It should be noted that the background service program of the user space, the background loading program of the user space, and the operating system all belong to a terminal device, and are used for interaction between the terminal device and the processing device in an actual process.

This embodiment of the present invention provides the CPU scheduling method based on a heterogeneous multi-core system, where performance type information of an application program is acquired by means of interaction of application program information between a background service program of user space in a terminal device and a cloud in a processing device, and an operating system in the terminal device is enabled to schedule a CPU for the application program according to the performance type information of the application program by using a background loading program of the user space in the terminal device, so as to implement CPU scheduling for the heterogeneous multi-core system, properly use resources, improve system performance, and give full play to advantages of the heterogeneous multi-core system.

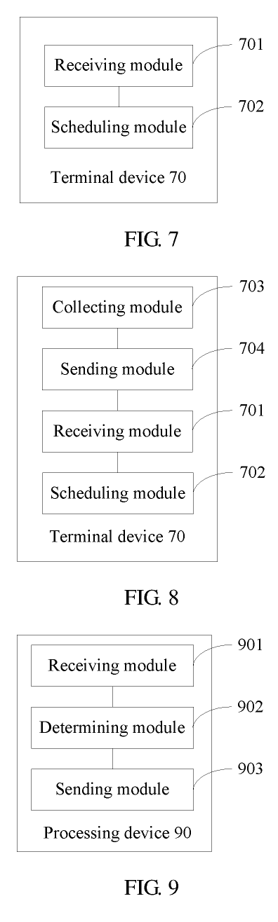

An embodiment of the present invention provides a terminal device, where various functional modules in the terminal device are corresponding to the steps of the foregoing method that is executed by a terminal device, and details are not described herein. As shown in FIG. 7, the terminal device 70 includes:

a receiving module 701, configured to receive performance type information that is of an application program and sent by a processing device; and

a scheduling module 702, configured to schedule a CPU for the application program according to the performance type information that is of the application program and obtained by the receiving module 701.

Optionally, as shown in FIG. 8, before the receiving module 701 receives the performance type information that is of the application program and sent by the processing device, the terminal device further includes:

a collecting module 703, configured to collect running information of the application program; and

a sending module 704, configured to send the running information that is of the application program and obtained by the collecting module 703 to the processing device, so that the processing device determines the performance type information of the application program according to the running information of the application program.

Optionally, the collecting module 703 is specifically configured to collect the running information of the application program according to a preset time interval by using a preset collector.

Optionally, the sending module 704 is specifically configured to send the running information that is of the application program and obtained by the collecting module 703 to the processing device, so that the processing device performs a statistical analysis on the running information of the application program, so as to obtain the performance type information of the application program.

This embodiment of the present invention provides a CPU scheduling apparatus based on a heterogeneous multi-core system, where performance type information that is of an application program and sent by a processing device is received, and a CPU is scheduled for the application program according to the performance type information that is of the application program and obtained by a receiving module, so as to implement CPU scheduling for the heterogeneous multi-core system, properly use resources, improve system performance, and give full play to advantageous of the heterogeneous multi-core system.

An embodiment of the present invention provides a processing device, where various functional modules in the processing device are corresponding to the steps of the foregoing method that is executed by a processing device, and details are not described herein. As shown in FIG. 9, the processing device 90 includes:

a receiving module 901, configured to receive running information that is of an application program and sent by a terminal device, where the running information of the application program is obtained by the terminal device by means of collection;

a determining module 902, configured to determine performance type information of the application program according to the running information that is of the application program and received by the receiving module 901; and

a sending module 903, configured to send the performance type information that is of the application program and obtained by the determining module 902 to the terminal device, so that the terminal device schedules a CPU for the application program according to the performance type information of the application program.

Optionally, that the running information of the application program is obtained by the terminal device by means of collection includes: the running information of the application program is obtained by the terminal device by means of collection according to a preset time interval by using a preset collector.

Optionally, the determining module 902 is specifically configured to perform a statistical analysis on the running information of the application program, so as to determine the performance type information of the application program.

This embodiment of the present invention provides a CPU scheduling apparatus based on a heterogeneous multi-core system, where running information that is of an application program and sent by a terminal device is received, performance type information of the application program is determined according to the running information of the application program, and the performance type information of the application program is sent to the terminal device, so that the terminal device schedules a CPU for the application program according to the performance type information of the application program, so as to implement CPU scheduling for the heterogeneous multi-core system, properly use resources, improve system performance, and give full play to advantages of the heterogeneous multi-core system.

An embodiment of the present invention further provides a CPU scheduling system based on a heterogeneous multi-core system, including the terminal device shown in FIG. 7 or FIG. 8 and the processing device shown in FIG. 9.

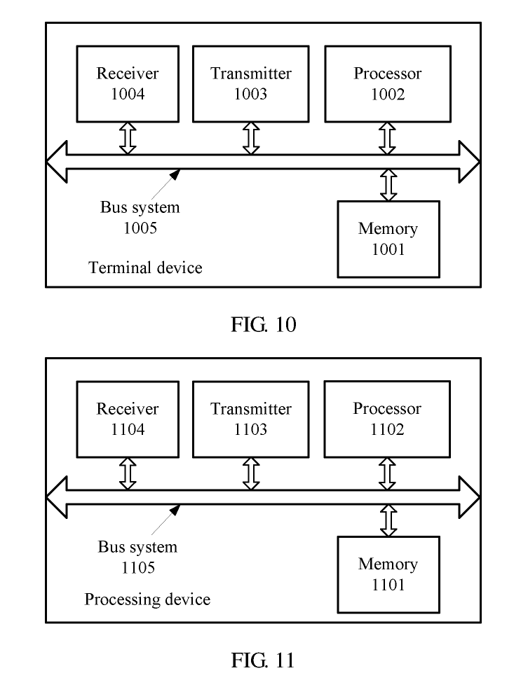

As shown in FIG. 10, this embodiment of the present invention provides a terminal device, where the terminal device includes a memory 1001, a processor 1002, a transmitter 1003, a receiver 1004, and a bus system 1005.

The memory 1001 may include a read-only memory and a random access memory, and provide an instruction and data for the processor 1002. A part of the memory 1001 may further include a non-volatile random access memory (NVRAM).

The memory 1001 stores the following elements: an executable module or a data structure, or a subset thereof, or an extended set thereof:

Operating instructions include various operating instructions, which are used to implement various operations.

An operating system includes various system programs, which are used to implement various basic services and process hardware-based tasks.

In this embodiment of the present invention, the processor 1002 invokes an operating instruction stored in the memory 1001 to execute, by using the transmitter 1003 and the receiver 1004, the following operations: receiving performance type information that is of an application program and sent by a processing device; and scheduling a CPU for the application program according to the performance type information of the application program.

Optionally, the processor 1002 is further configured to: before the receiver 1004 receives the performance type information that is of the application program and sent by the processing device, collect running information of the application program, and send the running information of the application program to the processing device, so that the processing device determines the performance type information of the application program according to the running information of the application program.

Optionally, the processor 1002 is further configured to collect the running information of the application program according to a preset time interval by using a preset collector.

Optionally, the processor 1002 is further configured to send the running information of the application program to the processing device, so that the processing device performs a statistical analysis on the running information of the application program, so as to obtain the performance type information of the application program.

The processor 1002 may be, for example, a CPU The memory 1001 may include a read-only memory and a random access memory, and provide an instruction and data for the processor 1002. A part of the memory 1001 may further include a non-volatile random access memory. In a specific application, all components of the CPU scheduling system based on a heterogeneous multi-core system are coupled together by using the bus system 1005, where in addition to a data bus, the bus system 1005 includes a power bus, a control bus, a status signal bus, and the like. However, for clarity of description, various buses are marked as the bus system 1005 in the diagram.

The methods disclosed in the foregoing embodiments of the present invention may be applied to the processor 1002, or implemented by the processor 1002. The processor 1002 may be an integrated circuit chip and has a signal processing capability. In an implementation process, the steps in the foregoing methods may be completed by using an integrated logic circuit of hardware in the processor 1002 or an instruction in a form of software. The processor 1002 may be a general processor, a digital signal processor (DSP), an application-specific integrated circuit (ASIC), a field programmable gate array (FPGA) or another programmable logic device, a discrete gate or transistor logic device, or a discrete hardware assembly, which may implement or perform the methods, the steps, and the logical block diagrams disclosed in the embodiments of the present invention. The general processor 1002 may be a microprocessor 1002, or the processor 1002 may be any conventional processor 1002, or the like. The steps of the methods disclosed in the embodiments of the present invention may be directly executed by a hardware decoding processor 1002, or executed by a combination of hardware and software modules in a decoding processor 1002. The software module may be located in a mature storage medium in the field, such as a random access memory 1001, a flash memory, a read-only memory 1001, a programmable read-only memory 1001, an electrically-erasable programmable memory 1001, or a register. The storage medium is located in the memory 1001. The processor 1002 reads information from the memory 1001, and completes the steps of the foregoing methods in combination with the hardware.

As shown in FIG. 11, this embodiment of the present invention provides a processing device, where the processing device includes a memory 1101, a processor 1102, a transmitter 1103, a receiver 1104, and a bus system 1105.

The memory 1101 may include a read-only memory and a random access memory, and provide an instruction and data for the processor 1102. A part of the memory 1101 may further include a non-volatile random access memory.

The memory 1101 stores the following elements: an executable module or a data structure, or a subset thereof, or an extended set thereof:

Operating instructions include various operating instructions, which are used to implement various operations.

An operating system includes various system programs, which are used to implement various basic services and process hardware-based tasks.

In this embodiment of the present invention, the processor 1102 invokes an operating instruction stored in the memory 1101 to perform, by using the transmitter 1103 and the receiver 1104, the following operations: receiving running information that is of an application program and sent by a terminal device, where the running information of the application program is obtained by the terminal device by means of collection; determining performance type information of the application program according to the running information of the application program; and sending the performance type information of the application program to the terminal device, so that the terminal device schedules a CPU for the application program according to the performance type information of the application program.

Optionally, the processor 1102 is specifically configured to perform a statistical analysis on the running information of the application program, so as to determine the performance type information of the application program.

The processor 1102 may be, for example, a CPU. The memory 1101 may include a read-only memory and a random access memory, and provide an instruction and data for the processor 1102. A part of the memory 1101 may further include a non-volatile random access memory. In a specific application, all components of the CPU scheduling system based on a heterogeneous multi-core system are coupled together by using the bus system 1105, where in addition to a data bus, the bus system 1105 includes a power bus, a control bus, a status signal bus, and the like. However, for clarity of description, various buses are marked as the bus system 1105 in the diagram.

The methods disclosed in the foregoing embodiments of the present invention may be applied to the processor 1102, or implemented by the processor 1102. The processor 1102 may be an integrated circuit chip and has a signal processing capability. In an implementation process, the steps in the foregoing methods may be completed by using an integrated logic circuit of hardware in the processor 1102 or an instruction in a form of software. The processor 1102 may be a general processor, a DSP, an ASIC, a FPGA or another programmable logic device, a discrete gate or transistor logic device, or a discrete hardware assembly, which may implement or perform the methods, the steps, and the logical block diagrams disclosed in the embodiments of the present invention. The general processor 1102 may be a microprocessor 1102, or the processor 1102 may be any conventional processor 1102, or the like. The steps of the methods disclosed in the embodiments of the present invention may be directly executed by a hardware decoding processor 1102, or executed by a combination of hardware and software modules in a decoding processor 1102. The software module may be located in a mature storage medium in the field, such as a random access memory 1101, a flash memory, a read-only memory 1101, a programmable read-only memory 1101, an electrically-erasable programmable memory 1101, or a register. The storage medium is located in the memory 1101. The processor 1102 reads information from the memory 1101, and completes the steps of the foregoing methods in combination with the hardware.

In the several embodiments provided in the present application, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit. The integrated unit may be implemented in a form of hardware, or may be implemented in a form of hardware in addition to a software functional unit.

When the foregoing integrated unit is implemented in a form of a software functional unit, the integrated unit may be stored in a computer-readable storage medium. The software functional unit is stored in a storage medium and includes several instructions for instructing a computer device (which may be a personal computer, a server, or a network device) to perform some of the steps of the methods described in the embodiments of the present invention. The foregoing storage medium includes: any medium that can store program code, such as a USB flash drive, a removable hard disk, a read-only memory (ROM), a random access memory (RAM), a magnetic disk, or an optical disc.

Finally, it should be noted that the foregoing embodiments are merely intended for describing the technical solutions of the present invention but not for limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A CPU scheduling method based on a heterogeneous multi-core system, comprising:
receiving performance type information that is of an application program and sent by a processing device; and
scheduling a CPU for the application program according to the performance type information of the application program.

2. The CPU scheduling method according to claim 1, wherein before the receiving performance type information that is of an application program and sent by a processing device, the method further comprises:
collecting running information of the application program; and
sending the running information of the application program to the processing device, so that the processing device determines the performance type information of the application program according to the running information of the application program.

3. The CPU scheduling method according to claim 2, wherein the collecting running information of the application program comprises:
collecting the running information of the application program according to a preset time interval by using a preset collector.

4. The CPU scheduling method according to claim 2, wherein the sending the running information of the application program to the processing device, so that the processing device determines the performance type information of the application program according to the running information of the application program comprises:
sending the running information of the application program to the processing device, so that the processing device performs a statistical analysis on the running information of the application program, so as to obtain the performance type information of the application program.

5. A CPU scheduling method based on a heterogeneous multi-core system, comprising:
receiving running information that is of an application program and sent by a terminal device, wherein the running information of the application program is obtained by the terminal device by means of collection;
determining performance type information of the application program according to the running information of the application program; and
sending the performance type information of the application program to the terminal device, so that the terminal device schedules a CPU for the application program according to the performance type information of the application program.

6. The CPU scheduling method according to claim 5, wherein that the running information of the application program is obtained by the terminal device by means of collection comprises:
the running information of the application program is obtained by the terminal device by means of collection according to a preset time interval by using a preset collector.

7. The CPU scheduling method according to claim 5, wherein the determining performance type information of the application program according to the running information of the application program comprises:
performing a statistical analysis on the running information of the application program, so as to determine the performance type information of the application program.

8. A terminal device, comprising:
a memory;
a processor, configured to execute program codes stored in the memory; and
the program codes comprise instructions for:
receiving performance type information that is of an application program and sent by a processing device; and
scheduling a CPU for the application program according to the performance type information that is of the application program.

9. The terminal device according to claim 8, wherein before receiving the performance type information that is of the application program and sent by the processing device, the program codes further comprise instructions for:
collecting running information of the application program; and
sending the running information that is of the application program to the processing device, so that the processing device determines the performance type information of the application program according to the running information of the application program.

10. The terminal device according to claim 9, wherein the program codes comprise instructions for:
collecting the running information of the application program according to a preset time interval by using a preset collector.

11. The terminal device according to claim 9, wherein the program codes comprise instructions for:
sending the running information that is of the application program to the processing device, so that the processing device performs a statistical analysis on the running information of the application program, so as to obtain the performance type information of the application program.

12. A processing device, comprising:
a memory;
a processor, configured to execute program codes stored in the memory; and
the program codes comprise instructions for:
receiving running information that is of an application program and sent by a terminal device, wherein the running information of the application program is obtained by the terminal device by means of collection;
determining performance type information of the application program according to the running information that is of the application program; and
sending the performance type information that is of the application program to the terminal device, so that the terminal device schedules a CPU for the application program according to the performance type information of the application program.

13. The processing device according to claim 12, wherein the program codes comprise instructions for:
performing a statistical analysis on the running information of the application program, so as to determine the performance type information of the application program.
